(19) United States
(12) Patent Application Publication
(10) Pub. No.: US 2008/0076870 A1
(43) Pub. Date: Mar. 27, 2008

(54) COMPOSITION, FILM AND PRODUCTION METHOD THEREOF

(75) Inventor: Hidetoshi HIRAOKA, Shizuoka (JP)

Correspondence Address: SUGHRUE-265550, 2100 PENNSYLVANIA AVE. NW, WASHINGTON, DC, 20037-3213, US

(73) Assignee: FUJIFILM CORPORATION, Tokyo (JP)

(21) Appl. No.: 11/855,239

(22) Filed: Sep. 14, 2007

(30) Foreign Application Priority Data
Sep. 25, 2006 (JP) 2006-258869

(51) Int. Cl. C08L 83/04; C08L 83/00

(52) U.S. Cl. 524/588

(57) ABSTRACT

A film forming composition includes a compound (I) having m pieces of RSi(O_{0.5})₃ units or a reaction product of the compound (I); and an antioxidant, wherein m represents an integer from 8 to 16; each of Rs independently represents a non-hydrolyzable group; and each of the units is linked with other units by sharing the oxygen atoms to form a cage structure.

### BACKGROUND OF THE INVENTION

1. Field of the Invention

The present invention relates to a composition, more specifically, a film forming composition. Further specifically, it relates to a composition which is, as an interlayer insulating film material in semiconductor devices or the like, capable of forming a coat having an adequate and uniform thickness and in addition, useful for forming an insulating film excellent in dielectric constant properties or forming an optical film with a low refractive index; a process for producing a film, a film, and a semiconductor device.

2. Description of the Related Art

A silica (SiO₂) film formed by a vacuum process such as chemical vapor deposition (CVD) has conventionally been used frequently as an interlayer insulating film for use in a semiconductor device and the like. With a purpose of forming a more uniform interlayer insulating film, an insulating film of an application type composed mainly of a hydrolysate of a tetraalkoxysilane, which is called SOG (Spin on Glass) film, has recently been used. With an increase in the integration degree of a semiconductor device or the like, a low-dielectric-constant interlayer insulating film composed mainly of a polyorganosiloxane which is called organic SOG is under development.

Even a CVD-SiO₂ film showing the lowest dielectric constant among films made of an inorganic material has however a specific dielectric constant of about 4. A SiOF film which has recently been investigated as a low-dielectric-constant CVD film has a specific dielectric constant of from about 3.3 to 3.5, but this film has a problem that owing to a high hygroscopic property, its dielectric constant increases inevitably during use.

Under such situations, known is a process for obtaining an insulating film material excellent in insulation properties, heat resistance and durability by adding a high-boiling-point solvent or thermally decomposable compound to an organopolysiloxane to form pores therein, thereby reducing the dielectric constant thereof. Even if a dielectric constant can be reduced by making the material porous, however, such a porous film has problems, for example, deterioration in mechanical strength and increase in dielectric constant due to moisture absorption. Another problem is that since mutually linked pores are formed, copper used for wiring diffuses in the insulating film.

An attempt to use a siloxane compound having a cage structure for the production of an insulating film is already known (refer to JP-A-2005-154771 (the term “JP-A” as used herein means an unexamined published Japanese patent application)). It is however impossible to maintain the cage structure sufficiently during the preparation of a coating solution or production of the insulating film so that use of the compound is not so effective for reducing the density of the film and thereby reducing its dielectric constant as is expected.

### SUMMARY OF THE INVENTION

The invention provides a composition which is, as an interlayer insulating film material for use in semiconductor devices or the like, capable of forming a coat having an adequate and uniform thickness and in addition, suppressing a change in a dielectric constant of a film formed from the composition, which will otherwise occur by the storage of the film under high humidity conditions; a production process of a film; a film; and a semiconductor device. An “insulating film” is also referred to as a “dielectric film” or a “dielectric insulating film”, and these terms are not substantially distinguished.

According to the conventional technology, after an insulating film is stored under high humidity conditions after formation, its dielectric constant changes (increases) and it tends to remain high even by heating and drying. The present inventors have therefore carried out an intensive investigation. As a result, it has been found that the dielectric constant of the insulating film to which an antioxidant has been added returns to that before the storage by heating and drying and therefore no change occurs in the quality of the film. Use of an antioxidant for an insulating film has already been revealed by JP-A-2000-109679, but use of it for a silicone film is not known at all. In addition, in the preferred mode of the present invention, decomposition of a cage structure, which is a problem in the conventional sol-gel reaction system, can be avoided by designing the compound so that an unsaturated hydrocarbon group is introduced in the cage structure as a functional group and a radical crosslinking reaction is utilized for increasing the molecular weight and curing into a film.

The following are the details of the invention.

<1> A film forming composition comprising:

a compound (I) having m pieces of RSi(O_{0.5})₃ units or a reaction product of the compound (I); and

an antioxidant,

wherein m represents an integer from 8 to 16;

each of Rs independently represents a non-hydrolyzable group; and

each of the units is linked with other units by sharing the oxygen atoms to form a cage structure.

<2> The film forming composition as described in <1>,

wherein at least two of Rs represent a group having a vinyl group or ethynyl group.

<3> The film forming composition as described in <1>,

wherein a polymer obtained by the reaction of a plurality of the compounds (I) accounts for 60 mass % or greater of a solid content in the composition.

<4> The film forming composition as described in <1>,

wherein the reaction product of the compound (I) has, in the molecule thereof, at least 16 Si atoms.

<5> The film forming composition as described in <1>,

wherein the antioxidant comprises at least one phenolic antioxidant.

<6> The film forming composition as described in <1>,

wherein the antioxidant comprises at least one hindered amine antioxidant.

<7> A production method of a film, comprising:

a process of applying the film forming composition as described in <1> onto a substrate; and

a process of cure the film forming composition into a film.

<8> A film produced by the production method as described in <7>.

<9> A semiconductor device comprising the film as described in <8>.

### DETAILED DESCRIPTION OF THE INVENTION

The invention will hereinafter be described more specifically.

The composition of the invention contains a compound (I) having m pieces of RSi(O_{0.5})₃ units (wherein m stands for an integer from 8 to 16 and Rs each independently represents a non-hydrolyzable group), each of which is linked to another unit via an oxygen atom possessed in common and thereby constitutes a cage structure, or a reaction product of the compound (I).

From the standpoint of a dielectric constant reducing effect, m stands for preferably 8, 10, 12, 14 or 16, and from the standpoint of availability, it stands for more preferably 8, 10 or 12.

The term “cage structure” as used herein means a molecule whose space is defined by a plurality of rings formed by covalent-bonded atoms and a point existing within the space cannot depart from the space without passing through these rings.

Examples of the cage structure represented by the compound (I) will be described below. A free bond in the below-described compounds means a position to which R is bonded.

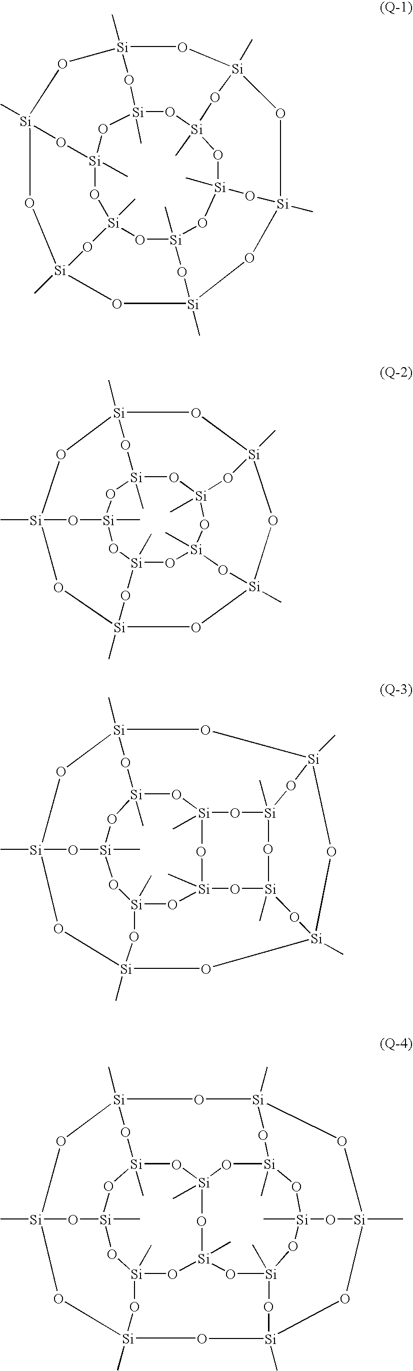

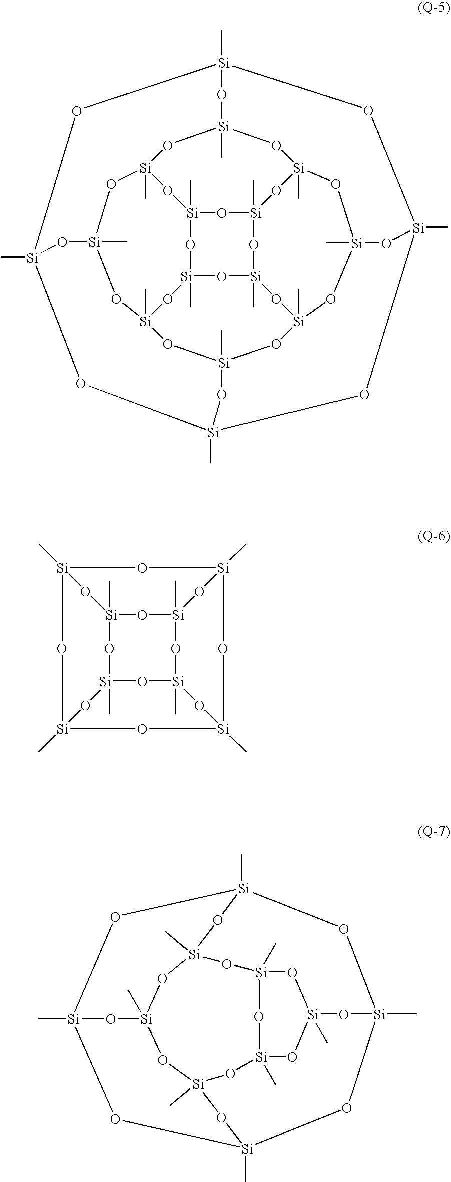

In the Compound (I), Rs each Independently Represents a non-Hydrolyzable group.

The term “non-hydrolyzable group” as used herein means a group at least 95% of which will remain when the group is brought into contact with one equivalent of neutral water for one hour at room temperature. A group at least 99% of which will remain under the above-described conditions is preferred.

Examples of the non-hydrolyzable group as R include alkyl groups (methyl, t-butyl, cyclopentyl, cyclohexyl and the like), aryl groups (phenyl, 1-naphthyl, 2-naphtyl and the like), vinyl group, ethynyl group, allyl group, and silyloxy groups (trimethylsilyloxy, triethylsilyloxy, t-butyldimethylsilyloxy, and the like).

It is preferred that at least two of the groups represented by R are each a vinyl- or ethynyl-containing group and it is more preferred that at least two of them are each a vinyl-containing group. When a group represented by R contains a vinyl or ethynyl group, the vinyl or ethynyl group is preferably bonded, directly or via a divalent linking group, to a silicon atom to which R is bonded. Examples of the divalent linking group include —[C(R¹¹)(R¹²)]ₖ—, —CO—, —O—, —N(R¹³)—, —S—, and —O—Si(R¹⁴)(R¹⁵)— (in which R¹¹ to R¹⁵ each independently represents a hydrogen atom methyl group or ethyl group and k stands for m integer from 1 to 6) and divalent linking groups obtained using the above-described groups in any combination. Of these, —[C(R¹¹)(R¹²)]ₖ—, —O—, and —O—Si(R¹⁴)(R¹⁵)— and divalent linking groups obtained using these groups in any combination are preferred.

In the compound (I), the vinyl or ethynyl group is preferably directly bonded to a silicon atom to which R is bonded.

It is more preferred that at least two vinyl groups of the Rs in the compound (I) are directly bonded to a silicon atom to which R is bonded. It is still more preferred that at least half of the Rs in the compound (I) are each a vinyl group. It is especially preferred that all the Rs represent a vinyl group.

Specific examples of the compound (I) include, but not limited to, the below-described compounds.

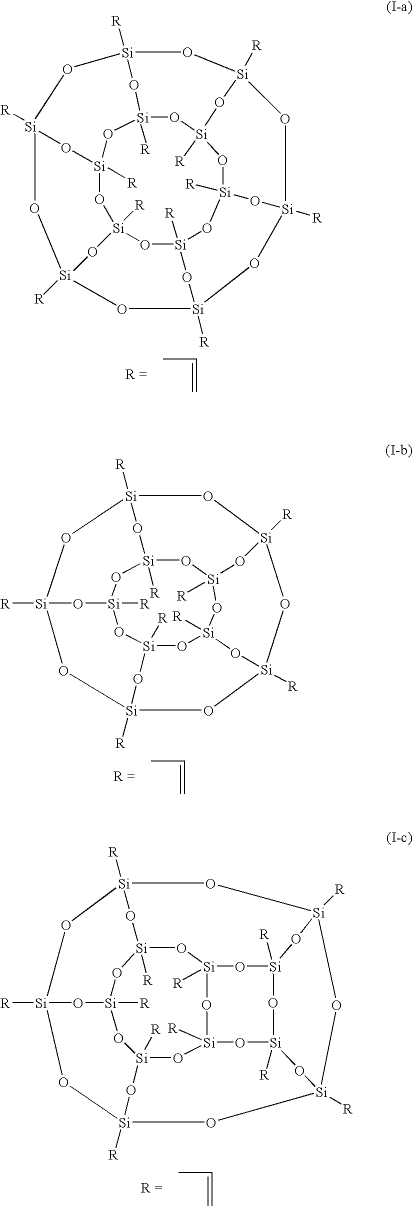

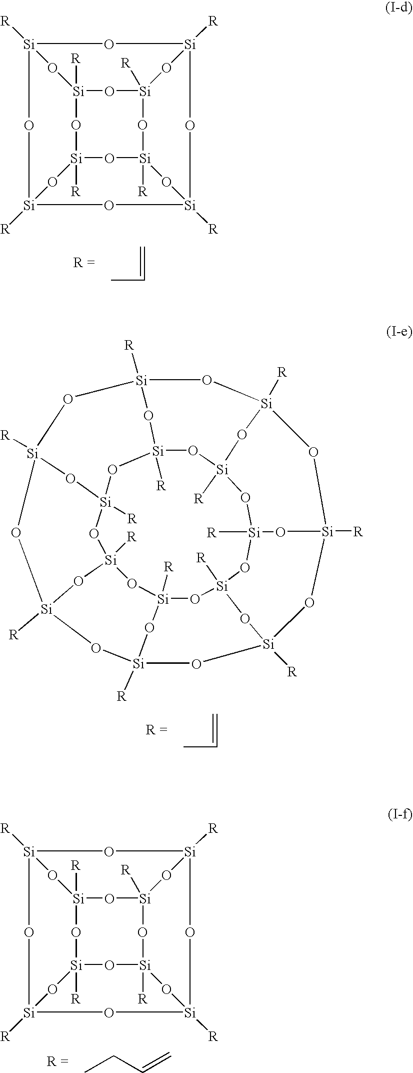

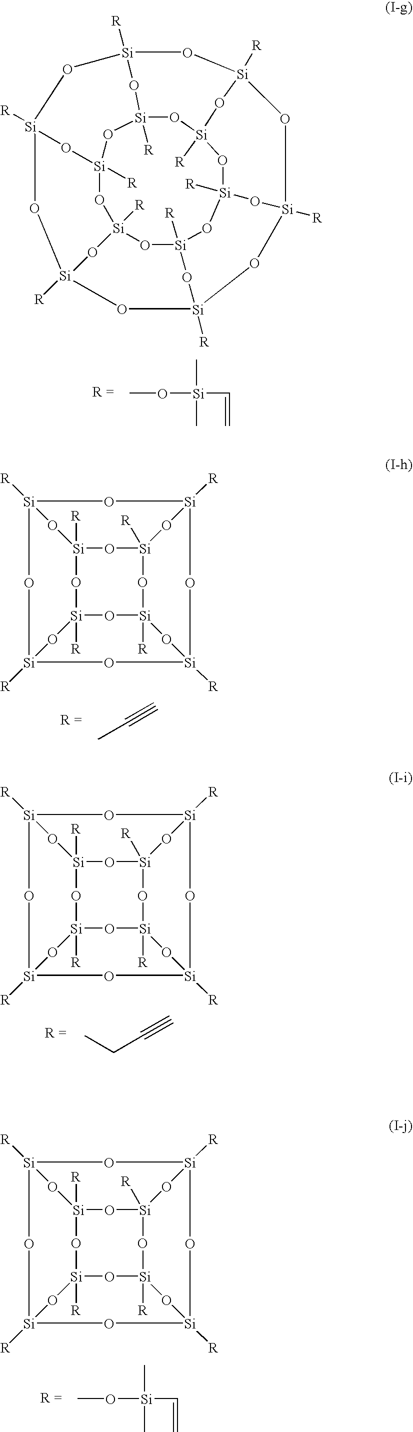

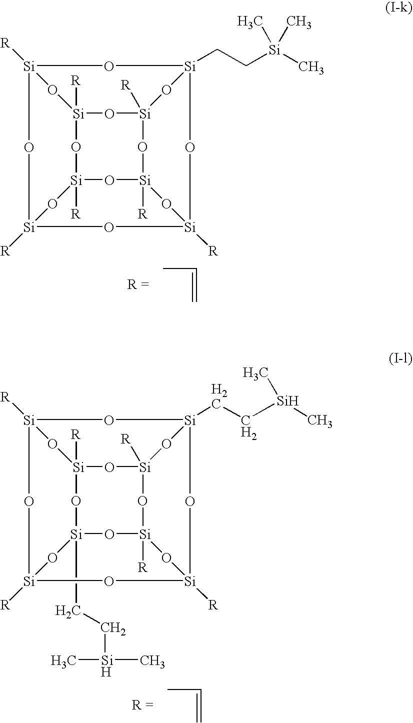

The compound (I) may be a commercially available compound or may be synthesized in a known manner (J. Am. Chem. Soc., 111, 1741 (1989) or the like).

In the compound (I) of the invention, R representing a group of the formula (II) is also preferred. In this case, it can be synthesized by reacting a compound of the formula (III) with a compound of the formula (IV).

The compound of the formula (III) can be synthesized in a process as described, for example, in Angew. Chem. Int. Ed. Engl., 36(7), 743-745 (1997).
(R¹)₃—Si—O— (II)
[MO—Si(O_{0.5})₃]ₘ (III)
(R¹)₃—Si—Cl (IV)

In the formula (II), R¹s each independently represents a non-hydrolyzable group. Specific examples of the non-hydrolyzable group represented by R¹ include alkyl groups, aryl groups, vinyl group and ethynyl group. In the formulas (III) and (IV), m and R¹ have the same meanings as described in the formulas (I) and (II). M represents a metal atom (such as Na, K, Cu, Ni or Mn) or an onium cation (such as tetramethylammonium). When M represents a polyvalent metal atom, a plurality of —O—Si(O_{0.5})₃s are bonded to the polyvalent metal atom M.

The reaction between the compound of the formula (III) and the compound of the formula (IV) is performed usually at from 0 to 180° C. for from 10 minutes to 20 hours by adding, to a solvent the compound of the formula (III) and from 1 to 100 times the mole, based on the number of Si—OM groups contained in the compound of the formula (III), of the compound of the formula (IV) under stirring.

As the solvent, organic solvents such as toluene, hexane and tetrahydrofuran (THF) are preferred.

When the compound of the formula (III) is reacted with the compound of the formula (IV), a base such as triethylamine or pyridine may be added.

The reaction product of the compound (I) in the composition of the invention contains preferably at least 16 Si atoms.

Examples of the reaction product of the compound (I) include polymers of a plurality of the compounds (I) and copolymers of the compound (I) and another monomer.

The composition of the invention may contain a plurality of compounds (I) different from each other or a polymer thereof. In this case, the composition may contain a copolymer composed of a plurality of the compounds (I) different from each other or a mixture of homopolymers of the compounds (I). When the composition of the invention contains a copolymer composed of a plurality of the compounds (I) different from each other, it is preferably a copolymer of a mixture of two or more compounds (I) selected from compounds (I) wherein m stands for 8, 10 and 12, respectively.

The composition of the invention may contain a copolymer of the compound (I) and another monomer. As the another monomer used in such a case, compounds having a polymerizable carbon-carbon unsaturated bond or compounds having a plurality of SiH groups are preferred. Preferred examples of the compounds include vinylsilanes, vinylsiloxanes, phenylacetylenes and [(HSiO_{0.5})₃]₈.

The composition of the invention may be a solution of the compound (I) or reaction product thereof dissolved in an organic solvent or may be a solid containing the compound (I) or reaction product thereof.

When the composition of the invention contains a polymer of a plurality of the compounds (I), the composition of the invention is prepared preferably by the hydrosilylation reaction of the compound (I) or polymerization reaction of plural carbon-carbon unsaturated bonds.

It is especially preferred to dissolve the compound (I) in a solvent and then add a polymerization initiator to the resulting solution to cause reaction of a vinyl or ethynyl group.

Although any polymerization reaction can be employed, examples include radical polymerization, cationic polymerization, anionic polymerization, ring-opening polymerization, polycondensation, polyaddition, addition condensation and polymerization in the presence of a transition metal catalyst.

The polymerization reaction of the compound (I) is performed preferably in the presence of a non-metal polymerization initiator. For example, polymerization can be effected in the presence of a polymerization initiator that generates, by heating, a free radical such as carbon radical or oxygen radical and shows activity.

As the polymerization initiator, an organic peroxide or organic azo compound is preferred. Examples of the organic peroxide include ketone peroxides such as “PERHEXA H”, peroxyketals such as “PERHEXA TMH”, hydroperoxides such as “PERBUTYL H-69”, dialkyl peroxides such as “PERCUMYL D”, “PERBUTYL C” and “PERBUTYL D”, diacyl peroxides such as “NYPER BW”, peroxyesters such as “PERBUTYL Z” and “PERBUTYL L”, and peroxydicarbonates such as “PEROYL TCP”, (each, trade name; commercially available from NOF Corporation), and “Luperox 11” (trade name, commercially available from ARKEMA Yoshitomi).

Examples of the organic azo compound include azonitrile compounds such as “V-30”, “V-40”, “V-59”, “V-60”, “V-65” and “V-70”, azoamide compounds such as “VA-080”, “VA-085”, “VA-086”, “VF-096”, “VAm-110” and “YAm-111”, cyclic azoamidine compounds such as “VA-044” and “VA-061”, and azoamidine compounds such as “V-50”, and VA-057” (each, trade name, commercially available from Wako Pure Chemical Industries).

As the polymerization initiator, the organic peroxides are preferred.

In the invention, these polymerization initiators may be used either singly or as a mixture of two or more of them.

In the invention, the polymerization initiator is used in an amount of preferably from 0.001 to 2 moles, more preferably from 0.05 to 1 mole, especially preferably from 0.01 to 0.5 mole, per mole of the monomer.

Examples of the adding method of the polymerization initiator in the invention include batch addition, divided addition and continuous addition. Of these, batch addition and continuous addition are preferred because they enable preparation of a polymer having a high molecular weight even if the amount of the polymerization initiator is small.

For the polymerization reaction, any solvent is usable insofar as it can dissolve the compound (I) therein at a required concentration and does not adversely affect the properties of the film formed from the polymer thus obtained. Examples of the solvent include water; alcohol solvents such as methanol, ethanol and propanol; ketone solvents such as acetone, methyl ethyl ketone, methyl isobutyl ketone, cyclohexanone and acetophenone; ester solvents such as methyl acetate, ethyl acetate, propyl acetate, isopropyl acetate, butyl acetate, pentyl acetate, hexyl acetate, methyl propionate, ethyl propionate, propylene glycol monomethyl ether acetate, γ-butyrolactone and methyl benzoate; ether solvents such as dibutyl ether, anisole and tetrahydrofuran; aromatic hydrocarbon solvents such as toluene, xylene, mesitylene, 1,2,4,5-tetramethylbenzene, pentamethylbenzene, isopropylbenzene, 1,4-diisopropylbenzene, t-butylbenzene, 1,4-di-t-butylbenzene, 1,3,5-triethylbenzene, 1,3,5-tri-t-butylbenzene, 4-t-butyl-orthoxylene, 1-methylnaphthalene and 1,3,5-triisopropylbenzene; amide solvents such as N-methylpyrrolidinone and dimethylacetamide; halogen solvents such as carbon tetrachloride, dichloromethane, chloroform, 1,2-dichloroethane, chlorobenzene, 1,2-dichlorobenzene and 1,2,4-trichlorobenzene; and aliphatic hydrocarbon solvents such as hexane, heptane, octane and cyclohexane. Of these solvents, preferred are the ester solvents, of which methyl acetate, ethyl acetate, propyl acetate, isopropyl acetate, butyl acetate, pentyl acetate, hexyl acetate, methyl propionate, ethyl propionate, propylene glycol monomethyl ether acetate, γ-butyrolactone, and methyl benzoate are more preferred, with ethyl acetate and butyl acetate being especially preferred.

These solvents may be used either singly or as a mixture of two or more.

When the solvent is the same, as the concentration of the compound (I) at the time of polymerization is smaller, a composition having a greater mass average molecular weight and a greater number average molecular weight and soluble in an organic solvent can be synthesized easily. In this sense, the concentration of the compound (I) in the reaction mixture is preferably 30 mass % or less, more preferably 10 mass % or less, still more preferably 5 mass % or less.

The productivity at the time of the reaction is, on the other hand, better when the concentration of the compound (I) at the time of polymerization is higher. In this sense, the concentration of the compound (I) at the time of polymerization is preferably 0.1 mass % or greater, more preferably 1 mass % or greater.

The optimum conditions of the polymerization reaction in the invention differ, depending on the kind, concentration or the like of the polymerization initiator, monomer or solvent. The polymerization reaction is effected at a bulk temperature preferably from 0 to 200° C., more preferably from 40 to 170° C., especially preferably from 70 to 150° C. for a polymerization time of preferably from 1 to 50 hours, more preferably from 2 to 20 hours, especially preferably from 3 to 10 hours.

The reaction is conducted preferably in an inert gas atmosphere (for example, nitrogen or argon gas atmosphere) in order to suppress the inactivation of the polymerization initiator which will otherwise occur by oxygen. The oxygen concentration during the reaction is preferably 100 ppm or less, more preferably 50 ppm or less, especially preferably 20 ppm or less.

The mass average molecular weight (Mw) of the polymer available by the polymerization ranges preferably from 5000 to 1000000, more preferably 20000 to 800000, especially preferably from 80000 to 600000.

The compound (I) and the polymer obtained by the reaction of a plurality of the compounds (I), in total, account for preferably 60 mass % or greater, more preferably 80 mass % or greater, still more preferably 90 mass % or greater, most preferably 95 mass % or greater, each of the solid content in the composition of the invention. The polymer obtained by the reaction of a plurality of the compounds (I) accounts for preferably 60 mass % or greater, more preferably 80 mass % or greater, still more preferably 90 mass % or greater, most preferably 95 mass % or greater.

As the content of them in the solid content is greater, a film having a low density, low refractive index and low dielectric constant can be formed.

The term “solid content” as used herein means a component that has remained after volatile components are subtracted from all the components contained in the composition. The volatile components include components that volatilize after decomposition into a low molecular compound. Examples of the volatile components include water, organic solvent, thermally decomposable polymer and thermal desorption substituent.

Examples of the component contained in the solid content of the invention but other than the polymer obtained by the reaction of a plurality of the compounds (I) include a nonvolatile compound (I), a component contained in the copolymer of the compound (I) but other than the reaction product of the compound (I), and a nonvolatile additive.

The amount of the remaining compound (I) can be determined from the GPC chart, HPLC chart, NMR spectrum, UV spectrum, IR spectrum or the like of the solid content. The amount of the component in the copolymer can be sometimes determined from a charge ratio, but can also be determined from the NMR spectrum, UV spectrum, IR spectrum or elementary analysis of the solid content which has been purified in advance if necessary.

The nonvolatile additive can be quantitatively determined by a method using the addition amount of it as an amount present in the solid content or determined from the GPC chart or HPLC chart of the solid. It is also possible to determine the amount of the nonvolatile additive by purifying the solid if necessary and then subjecting it to NMR spectrum, UV spectrum, IR spectrum or elementary analysis.

The amount of the polymer obtained by the reaction of a plurality of the compounds (I) is thus a remainder after the above-described components are subtracted from the solid content.

The composition of the invention is characterized in that it further contains an antioxidant further. Addition of an antioxidant enables to prevent deterioration of properties such as rise in dielectric constant due to oxidation of a film which has occurred in steps such as photolithography and CMP.

As the antioxidant, those listed in “Plastic Additives, New Edition: Fundamental and Application” published by Taiseisha, “Antioxidant Handbook”, published by Taiseisha, “Plastic Additives Note”, published by Kogyo Chosakai and the like can be used.

The antioxidant usable in the invention has a mass average molecular weight of preferably from 100 to 50000, more preferably from 150 to 30000, especially preferably from 200 to 20000.

As the antioxidant, phenolic antioxidants, hindered amine antioxidants, sulfur antioxidants and phosphorus antioxidants are preferred, with phenolic antioxidants and hindered amine antioxidants being especially preferred.

Phenolic antioxidants having, in the molecule thereof, at least one below-described structure are preferred.

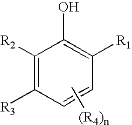

In the above formula, R₁, R₂ and R₃ each independently represents a hydrogen atom, methyl group, t-butyl group or linking group, and at least one of R₁, R₂ and R₃ is a t-butyl group and at most one of the remaining two is a hydrogen atom. R₁ to R₃ may link a plurality of the above-described structures while serving as a linking group (preferably, divalent to tetravalent).

R₄ represents a hydrogen atom or a substituent. Examples of the substituent include halogen atoms (fluorine and chlorine), alkyl groups (C₁₋₂₀ alkyl groups such as methyl, ethyl, propyl, isopropyl, butyl, 2-butyl, hexyl, octyl, 2-ethylhexyl, cyclohexyl, dodecyl, tetradecyl and hexadecyl), aryl groups (C₂₋₂₀ aryl groups such as phenyl and 1-naphthyl), heterocyclic groups (C₁₋₂₀ heterocyclic groups such as 4-piperidinyl, 2-furyl and 2-pyranyl), alkoxy groups (C₁₋₂₀ alkoxy groups such as methoxy, ethoxy, propoxy, butoxy, 2-butoxy, 2-ethylhexyloxy, dodecyloxy and cyclohexyloxy), aryloxy groups (C₆₋₂₀ aryloxy groups such as phenoxy an 1-naphthoxy), acyloxy groups (C₂₋₂₀ acyloxy groups such as acetoxy, butoxy and benzoyloxy), alkoxycarbonyloxy groups (C₂₋₂₀ alkoxycarbonyloxy groups such as methoxycarbonyloxy and ethoxycarbonyloxy), amino groups (C₀₋₂₀ amino groups such as amino, methylamino, 2-ethylhexylamino, tetradecylamino and cyclohexylamino), arylamino groups (C₆₋₂₀ arylamino groups such as anilino and 1-naphthylamino), acylamino groups (C₂₋₂₀ acylamino groups such as acetylamino, butanoylamino and benzoylamino), alkoxycarbonylamino groups (C₂₋₂₀ alkoxycarbonylamino groups such as methoxycarbonylamino, ethoxycarbonylamino and cyclohexyloxycarbonylamino), aminocarbonylamino groups (C₁₋₂₀ aminocarbonylamino groups such as ureido and N,N-dimethylaminocarbonylamino), alkylthio groups (C₁₋₂₀ alkylthio groups such as methylthio, ethylthio, butylthio, octylthio, 2-ethylhexylthio, dodecylthio and cyclohexylthio), arylthio groups (C₆₋₂₀ arylthio groups such as phenylthio and 1-naphthylthio) and alkoxycarbonyl groups (C₂₋₂₀ alkoxycarbonyl groups such as methoxycarbonyl, ethoxycarbonyl, butoxycarbonyl, cyclohexyloxycarbonyl and dodecyloxycarbonyl). Of these, preferred substituents are alkyl groups and alkoxy groups, with alkyl groups being more preferred. The substituent may link, as a linking group (preferably, bivalent to tetravalent) a plurality of the above-described structures. R₄ is preferably a C₁₋₃₀ group and it may have, there in, an alkylene, —COO—, —OCO—, —O— or isocyanurate structure. “n” stands for an integer of from 0 to 3, preferably 1.

Specific examples of the phenolic antioxidants include 2,6-di-t-butyl-p-cresol, 4,4′-butylidenebis-(6-t-butyl-3-methylphenol), 2,2′-methylenebis-(4-methyl-6-t-butylphenol), 2,2′-methylenebis-(4-ethyl-6-t-butylphenol), 2,6-di-t-butyl-4-ethylphenol, 1,1,3-tris(2-methyl-4-hydroxy-5-t-butylphenyl)butane, n-octadecyl-3-(3,5-di-t-butyl-4-hydroxyphenyl)propionate, tetrakis[methylene-3-(3,5-di-t-butyl-4-hydroxyphenyl)propionate]methane, triethyleneglycolbis[3-(3-t-butyl-4-hydroxy-5-methylphenyl)propionate], tris(3,5-di-t-butyl-4-hydroxybenzyl)isocyanurate, dilaurylthiodipropionate, distearylthiodipropionate, dimyristylthiodipropionate, and 1,1,3-tris(2-methyl-4-hydroxy-5-t-butylphenol)butane.

The hindered amine antioxidants preferably have, in the molecule thereof, at least one below-described structure. 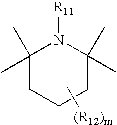
wherein, R₁₁ represents a hydrogen atom or a substituent, preferably hydrogen or a methyl group. R₁₂ represents a hydrogen atom or a substituent. Substituents given by the above-described R₄ are preferred as the substituent, of which alkyl groups, alkoxy groups, acyloxy groups, amino groups and acylamino groups are preferred, with acyloxy groups and amino groups being more preferred. The substituent may link a plurality of the hindered amine structures as a linking group having two or more valences. As the linking group, alkylene groups, —COO—, —OCO—, —O—, and isocyanurate structure and combination thereof are preferred. R₁₂ is preferably a C₁₋₃₀ group which may contain a nitrogen atom. The hindered amine antioxidants may be a polymer containing, in repeating units thereof, the above-described structure.

Specific examples of the hindered amine antioxidant include bis-(2,2,6,6-tetramethyl-4-piperidinyl)sebacate, bis-(N-methyl-2,2,6,6-tetramethyl-4-piperidinyl)sebacate, bis-(1,2,2,6,6-pentamethyl-4-piperidinyl)-2-(3,5-di-t-butyl-4-hydroxy-benzyl)-2-n-butylmalonate, tetrakis(2,2,66-tetramethyl-4-piperidinyl)-1,2,3,4-tbutanetetracarboxylate, tetrakis(1,2,2,6,6-pentamethyl-4-piperidinyl)-1,2,3,4,-butanetetracarboxylate.

The composition of the present invention may contain a sulfur antioxidant having a structure represented by the following formula: 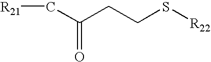
wherein, R₂₁ represents a hydrogen atom or a substituent, R₂₂ represents a hydrogen atom or a substituent and the substituent may link, as a linking group, a plurality of the above-described structures. Examples of the substituent include those which are exemplified as the substituent represented by R₄ and at the same time, coupled via a carbon atom. Alkyl groups are preferred. The substituent may have therein —COO—, —OCO—, or —O— and alkyl groups having —COO—, —OCO— or —O— are preferred.

Examples of the sulfur antioxidant include ditridecylthiodipropionate and pentaerythritoltetrakis(3-laurylthiopropionate).

The composition of the present invention may contain a phosphorus antioxidant having a structure represented by the following formula: 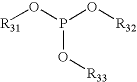
wherein, R₃₁, R₃₂ and R₃₃ each independently represents a substituent. Examples of the substituent include those given as the substituent represented by R₄ and at the same time, coupled via a carbon atom. Preferred examples of the substituent include alkyl groups and aryl groups. The alkyl groups may contain an ether bond. R₃₁, R₃₂ and R₃₃ may link a plurality of the above-described structures as a linking group. R₃₁ and R₃₂, R₃₁ and R₃₃ or R₃₂ and R₃₃ may be coupled to form a ring.

Examples of the phosphorus antioxidant include trisnonylphenylphosphite, tris(2,4-di-t-butylphenyl)phosphite, distearylpentaerythritoldiphosphite, bis(2,4-di-t-butylphenyl)pentaerythritolphosphite, 2,2-methylenebis(4,6-di-t-butylphenyl)octylphosphite, and tetrakis(2,4-di-t-butylphenyl)-4,4-biphenylene-di-phosphonite.

In the invention, these antioxidants may be used either singly or as a mixture of two or more.

The amount of the antioxidant in the invention is preferably from 0.001 to 50 parts by mass, more preferably from 0.005 to 10 parts by mass, especially preferably from 0.01 to 5 parts by mass based on 100 parts by mass of the compound (I) or the reaction product thereof contained in the composition.

Antioxidants which are commercially available or synthesized in a conventional manner can be used. Preferred examples of the commercially available antioxidants include “ADK STAB Series” (product of ADEKA), “Irganox Series” (products of Ciba Specialty Chemicals), “Sumilizer Series” (products of Sumitomo Chemical), “Antage Series” (products of Kawaguchi Chemical Industry) and “Yoshinox Series” (products of API corporation).

The composition of the invention is preferably soluble in an organic solvent. The term “soluble in an organic solvent” as used herein is defined as that 5 mass % or greater of the composition dissolves at 25° C. in a solvent selected from cyclohexanone, methyl ethyl ketone, methyl isobutyl ketone, propylene glycol monomethyl ether acetate, propylene glycol monomethyl ether and γ-butyrolactone. The amount of the composition which dissolves in the above-described solvent is preferably 10 mass % or greater, more preferably 20 mass % or greater.

The mass average molecular weight (Mw) of the solid in the composition as determined by GPC (polystyrene standard) is preferably from 5,000 to 1,000,000, more preferably from 20,000 to 800,000, still more preferably from 40,000 to 600,000, still more preferably from 80,000 to 600,000, most preferably from 120,000 to 600,000.

In the invention, the mass average molecular weight as determined by GPC (polystyrene standard) was obtained using “Waters 2695” and a GPC column “KF-805L” (trade name; product of Shodex) and, as an eluting solvent, tetrahydrofuran at a flow rate of 1 ml/min while setting a column temperature at 40° C.; injecting 50 μl of a tetrahydrofuran solution having a sample concentration of 0.5 mass %; and drawing a calibration curve for the monomer by utilizing an integrated value of an RI detector (“Waters 2414”) to determine the amount of the monomer in the solid. The Mn and Mw were values calculated based on a calibration curve drawn using standard polystyrene.

The GPC chart of the solid contained in the composition of the invention from which the compound (I) monomer has been subtracted has a polystyrene-equivalent weight-average molecular weight (Mw) of from 7,000 to 1,000,000, preferably from 25,000 to 800,000, more preferably from 50,000 to 600,000, still more preferably from 100,000 to 600,000, most preferably from 140,000 to 600,000.

A polystyrene-equivalent number average molecular weight (Mn) of the solid content in the composition of the invention as determined by the GPC is preferably from 1,000 to 300,000, more preferably from 3,000 to 250,000, still more preferably from 10,000 to 200,000, furthermore preferably from 20,000 to 200,000, most preferably from 30,000 to 200,000.

The GPC chart of the solid contained in the composition of the invention from which the compound (I) monomer has been subtracted has the Mn of preferably from 3,000 to 300,000, more preferably from 6,000 to 250,000, still more preferably from 12,000 to 200,000, furthermore preferably from 24,000 to 200,000, most preferably from 36,000 to 200,000.

As the average molecular weight is greater, it is possible to form a film having a lower density, lower refractive index and lower dielectric constant. A greater average molecular weight, however, tends to lead to the formation of insoluble matters in an organic solvent. The average molecular weights within the above-described range make it possible to satisfy low density, refractive index and dielectric constant as well as sufficient solubility and filterability in an organic solvent.

The polymer of the invention is preferably substantially free from a component having a molecular weight of 3,000,000 or greater, more preferably substantially free from a component having a molecular weight of 2,000,000 or greater, most preferably free from a component having a molecular weight of 1,000,000 or greater.

When the composition of the invention contains a polymer of a plurality of the compounds (I), the solid contained in Me composition of the invention has a polydispersity (Mw/Mn), as calculated from the GPC chart, preferably of from 1 to 15, more preferably from 1 to 10, most preferably from 1 to 5. When compositions have an equal Mw, a film having a lower density, lower refractive index and lower dielectric constant can be formed from a composition having a smaller polydispersity.

The amount of the unreacted compound (I) in the solid contained in the composition of the invention is 40 mass % or less, preferably 20 mass % or less, more preferably 10 mass % or less, still more preferably 5 mass % or less, most preferably 2 mass % or less.

In the solid contained in the composition of the invention, preferably from 1 to 90 mmole %, more preferably from 5 to 70 mole %, most preferably from 10 to 50 mole % of the vinyl groups or ethynyl groups of the compound (I) remain unreacted.

To the polymer of a plurality of the compounds (I) in the composition of the invention, from 0.1 to 40 mass %, preferably from 0.1 to 20 mass %, more preferably from 0.1 to 10 mass %, most preferably from 0.1 to 5 mass % of the polymerization initiator, additive or polymerization solvent may be bonded.

These amounts may be determined based on the NMR spectrum of the composition or the like.

The composition of the invention preferably contains a particulate polymer including the polymer of the compound (I). The particulate polymer has a particle size of preferably from 1 to 200 nm, more preferably from 2 to 100 nm, still more preferably from 3 to 50 mm, most preferably 3 to 10 nm. The particle size can be measured by a light scattering method or the like.

The composition having the above-described physical properties can be prepared by polymerizing the compound (I) while using high dilution conditions, adding a chain transfer agent, optimizing a reaction solvent, successively adding a polymerization initiator, successively adding the compound (I), adding a radical trapping agent, or the like.

It is also possible to filter off an insoluble matter, purify by column chromatography, purify by re-precipitation treatment or the like after polymerization of the compound (I).

The term “re-precipitation treatment” as used herein means collection, by filtration, of the composition of the invention which has been precipitated by adding a poor solvent (a solvent which does not substantially dissolve the composition of the invention therein) to the reaction mixture from which the reaction solvent has been removed as needed or by adding dropwise the reaction mixture, from which the reaction solvent has been removed as needed, to a poor solvent.

The poor solvent is preferably an alcohol (such as methanol, ethanol, or isopropyl alcohol) or a hydrocarbon (such as hexane or heptane). The poor solvent is added in an amount from equal to 200 times the mass, more preferably from 2 to 50 times the mass of the composition of the invention.

When the composition of the invention is prepared, the reaction mixture after the polymerization reaction of the compound (I) may be used as is as the composition of the invention. The reaction mixture is preferably used as a concentrate which has remained after the solvent is distilled off. In addition, the reaction mixture is preferably used after re-precipitation treatment.

The reaction mixture is concentrated preferably by heating and/or pressure reduction in a rotary evaporator distiller or reaction apparatus used for the polymerization reaction. The temperature of the reaction mixture at the time of concentration is usually from 0 to 180° C., preferably from 10 to 140° C., more preferably from 20 to 100° C., most preferably from 30 to 60° C. The pressure at the time of concentration is usually from 0.133 Pa to 100 kPa, preferably from 1.33 Pa to 13.3 kPa, more preferably from 1.33 Pa to 1.33 kPa.

When the reaction mixture is concentrated, it is concentrated until the solid content in the reaction mixture reaches preferably 10 mass % or greater more preferably 30 mass % or greater, most preferably 50 mass % or greater.

In the invention, the polymer of the compound (I) is preferably dissolved in an appropriate solvent and the resulting solution is then applied onto a substrate, Examples of the usable solvent include ethylene dichloride, cyclohexanone, cyclopentanone, 2-heptanone, methyl isobutyl ketone, γ-butyrolactone, methyl ethyl ketone, methanol, ethanol, dimethylimidazolidinone, ethylene glycol monomethyl ether, ethylene glycol monoethyl ether, ethylene glycol dimethyl ether, 2-methoxyethyl acetate, ethylene glycol monoethyl ether acetate, propylene glycol monomethyl ether (PGME), propylene glycol monomethyl ether acetate (PGMEA), tetraethylene glycol dimethyl ether, triethylene glycol monobutyl ether, triethylene glycol monomethyl ether, isopropanol, ethylene carbonate, ethyl acetate, butyl acetate, methyl lactate, ethyl lactate, methyl methoxypropionate, ethyl ethoxypropionate, methyl pyruvate, ethyl pyruvate, propyl pyruvate, N,N-dimethylformamide, dimethylacetamide, dimethylsulfoxide, N-methylpyrrolidone, tetrahydrofuran, diisopropylbenzene, toluene, xylene, and mesitylene. These solvents may be used either singly or as a mixture.

Of these solvents, preferred examples of the solvent include propylene glycol monomethyl ether acetate, propylene glycol monomethyl ether, 2-heptanone, cyclohexanone, γ-butyrolactone, ethylene glycol monomethyl ether, ethylene glycol monoethyl ether, ethylene glycol monoethyl ether acetate, propylene glycol monomethyl ether, propylene glycol monoethyl ether, ethylene carbonate, butyl acetate, methyl lactate, ethyl lactate, methyl methoxypropionate, ethyl ethoxypropionate, N-methylpyrrolidone, N,N-dimethylformamide, tetrahydrofuran, methyl isobutyl ketone, xylene, mesitylene and diisopropylbenzene.

A solution obtained by dissolving the composition of the invention in an appropriate solvent is also embraced in the scope of the composition of the invention. A total solid concentration in the solution of the invention is preferably from 1 to 30 mass %. It is suitably regulated according to the using purpose. When a total solid concentration of the composition falls within a range of from 1 to 30 mass %, the thickness of a coat falls within an appropriate range, and the coating solution has better storage stability.

The composition of the invention may contain a polymerization initiator, but the composition free of a polymerization initiator is preferred because it has better storage stability.

When the composition of the invention must be cured into a film at a low temperature, however, it preferably contains a polymerization initiator. In such a case, examples of the polymerization initiator may be the same as those cited above. Also an initiator that induces polymerization when exposed to radiation may also be used for this purpose.

The content of metals, as an impurity, of the film forming composition of the invention is preferably as small as possible. The metal content of the film forming composition can be measured with high sensitivity by the ICP-MS and in this case, the content of metals other than transition metals is preferably 30 ppm or less, more preferably 3 ppm or less, especially preferably 300 ppb or less. The content of the transition metal is preferably as small as possible because it accelerates oxidation by its high catalytic capacity and the oxidation reaction in the prebaking or thermosetting process decreases the dielectric constant of the film obtained by the invention. The metal content is preferably 10 ppm or less, more preferably 1 ppm or less, especially preferably 100 ppb or less.

The metal concentration of the film forming composition can also be evaluated by subjecting a film obtained using the film forming composition of the invention to total reflection fluorescent X-ray analysis. When W ray is employed as an X-ray source, the metal concentrations of metal elements such as K, Ca, Ti, Cr, Mn, Fe, Co, Ni, Cu, Zn, and Pd can be measured. The concentrations of them are each preferably from 100×10¹⁰ atom·cm⁻² or less, more preferably 50×10¹⁰ atom·cm⁻² or less, especially preferably 10×10¹⁰ atom·cm⁻² or less. In addition, the concentration of Br as a halogen can be measured. Its remaining amount is preferably 10000×10¹⁰ atom·cm⁻² or less, more preferably 1000×10¹⁰ atom·cm⁻², especially preferably 400×10¹⁰ atom·cm². Moreover, the concentration of Cl can also be observed as a halogen. In order to prevent it from damaging a CVD device, etching device or the like, its remaining amount is preferably 100×10¹⁰ atom·cm⁻² or less, more preferably 50×10¹⁰ atom·cm⁻², especially preferably 10×10¹⁰ atom·cm⁻².

To the film forming composition of the invention, additives such as radical generator, colloidal silica, surfactant, silane coupling agent and adhesive agent may be added without impairing the properties (such as heat resistance, dielectric constant, mechanical strength, coatability, and adhesion) of an insulating film obtained using it.

Any colloidal silica may be used in the invention. For example, a dispersion obtained by dispersing high-purity silicic anhydride in a hydrophilic organic solvent or water and having usually an average particle size of from 5 to 30 nm, preferably from 10 to 20 nm and a solid concentration of from about 5 to 40 mass % can be used.

Any surfactant may be added in the invention. Examples include nonionic surfactants, anionic surfactants and cationic surfactants. Further examples include silicone surfactants, fluorosurfactants, polyalkylene oxide surfactants, and acrylic surfactants. In the invention, these surfactants can be used either singly or in combination. As the surfactant, silicone surfactants, nonionic surfactants, fluorosurfactants and acrylic surfactants are preferred, with silicone surfactants being especially preferred.

The amount of the surfactant to be used in the invention is preferably from 0.01 mass % or greater but not greater than 1 mass %, more preferably from 0.1 mass % or greater but not greater than 0.5 mass % based on the total amount of the film forming coating solution.

The term “silicone surfactant” as used herein means a surfactant containing at least one Si atom. Any silicone surfactant may be used in the invention, but it preferably has a structure containing an alkylene oxide and dimethylsiloxane, of which a silicone surfactant having a compound represented by the following chemical formula is more preferred:

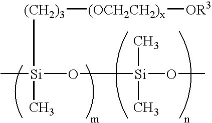

In the above formula, R³ represents a hydrogen atom or a C₁₋₅ alkyl group, x stands for an integer of from 1 to 20, and m and n each independently represents an integer of from 2 to 100. A plurality of R³s may be the same or different.

Examples of the silicone surfactant to be used in the invention include “BYK 306”, “BYK 307” (each, trade name; product of BYK Chemie), “SH7PA”, “SH21PA”, “SH28PA”, and “SH30PA” (each, trade name; product of Dow Corning Toray Silicone) and Troysol S366 (trade name; product of Troy Chemical).

As the nonionic surfactant to be used in the invention, any nonionic surfactant is usable. Examples include polyoxyethylene alkyl ethers, polyoxyethylene aryl ethers, polyoxyethylene dialkyl esters, sorbitan fatty acid esters, fatty-acid-modified polyoxyethylenes, and polyoxyethylene-polyoxypropylene block copolymers.

As the fluorosurfactant to be used in the invention, any fluorosurfactant is usable. Examples include perfluorooctyl polyethylene oxide, perfluorodecyl polyethylene oxide and perfluorododecyl polyethylene oxide.

As the acrylic surfactant to be used in the invention, any acrylic surfactant is usable. Examples include (meth)acrylic acid copolymer.

Any silane coupling agent may be used in the invention. Examples include 3-glycidyloxypropyltrimetoxysilane, 3-aminoglycidyloxypropyltriethoxysilane, 3-methacryloxypropyltrimethoxysilane, 3-glycidyloxypropylmethyldimethoxysilane, 1-methacryloxypropylmethyldimethoxysilane, 3-aminopropyltrimethoxysilane, 3-aminopropyltriethoxysilane, 2-aminopropyltrimethoxysilane, 2-aminopropyltriethoxysilane, N-(2-aminoethyl)-3-aminopropyltrimethoxysilane, N-(2-aminoethyl)-3-aminopropylmethyldimethoxysilane, 3-ureidopropyltrimethoxysilane, 3-ureidopropyltriethoxysilane, N-ethoxycarbonyl-3-aminopropyltrimethoxysilane, N-ethoxycarbonyl-3-aminopropyltriethoxysilane, N-triethoxysilylpropyltriethylenetriamine, N-triethoxysilylpropyltiethylenetriamine, 10-trimethoxysilyl-1,4,7-triazadecane, 10-triethoxysilyl-1,4,7-triazadecane, 9-trimethoxysilyl-3,6-diazanonyl acetate, 9-triethoxysilyl-3,6-diazanonyl acetate, N-benzyl-3-aminopropyltrimethoxysilane, N-benzyl-3-aminopropyltriethoxysilane, N-phenyl-3-aminopropyltrimethoxysilane, N-phenyl-3-aminopropyltriethoxysilane, N-bis(oxyethylene)-3-aminopropyltrimethoxysilane, and N-bis(oxyethylene)-3-aminopropyltriethoxysilane. Those silane coupling agents may be used either singly or in combination. The silane coupling agent may be added preferably in an amount of 10 parts by weight or less, especially preferably from 0.05 to 5 parts by weight based on 100 parts by weight of the whole solid content.

In the invention, any adhesion accelerator may be used. Examples include trimethoxysilylbenzoic acid, γ-methacryloxypropyltrimethoxysilane, vinyltriacetoxysilane, vinyltrimethoxysilane, γ-isocyanatopropyltriethoxysilane, γ-glycidoxypropyltrimethoxysilane, β-(3,4-epoxycyclohexyl)ethyltrimethoxysilane, trimethoxyvinylsilane, γ-aminopropyltriethoxysilane, aluminum monoethylacetoacetate disopropylate, vinyltris(2-methoxyethoxy)silane, N-(2-aminoethyl)-3-aminopropylmethyldimethoxysilane, N-(2-aminoethyl)-3-aminopropyltrimethoxysilane, 3-chloropropylmethyldimethoxysilane, 3-chloropropyltrimethoxysilane, 3-methacryloxypropyltrimethoxysilane, 3-mercaptopropyltrimethoxysilane, trimethylchlorosilane, dimethylvinylchlorosilane, methyldiphenylchlorosilane, chloromethyldimethylchlorosilane, trimethylmethoxysilane, dimethyldiethoxysilane, methyldimethoxysilane, dimethylvinylethoxysilane, diphenyldimethoxysilane, phenyltriethoxysilane, hexamethyldisilazane, N,N′-bis(trimethylsilyl)urea, dimethyltrimethylsilylamine, trimethylsilylimidazole, vinyltrichlorosilane, benzotriazole, benzimidazole, indazole, imidazole, 2-mercaptobenzimidazole, 2-mercaptobenzothiazole, 2-mercaptobenzoxazole, urazole, thiourasil, mercaptoimidazole, mercaptopyrimidine, 1,1-dimethylurea, 1,3-dimethylurea and thiourea compounds. A functional silane coupling agent is preferred as an adhesion accelerator. The amount of the adhesion accelerator is preferably 10 parts by weight or less, especially preferably from 0.05 to 5 parts by weight, based on 100 parts by weight of the total solid content.

It is possible to add a pore forming factor to the composition of the invention to the extent allowed by the mechanical strength of a film in order to make a film porous and thereby reduce the dielectric constant thereof.

Although the pore forming factor which will be an additive serving as a pore forming agent is not particularly limited, non-metallic compounds are preferred. They must satisfy both solubility in the solvent used for a film forming coating solution and compatibility with the polymer of the invention.

A polymer may also be used as the pore forming agent. Examples of the polymer usable as the pore forming agent include aromatic polyvinyl compounds (such as polystyrene, polyvinylpyridine, and halogenated aromatic polyvinyl compound), polyacrylonitrile, polyalkylene oxides (such as polyethylene oxide and polypropylene oxide), polyethylene, polylactic acid, polysiloxane, polycaprolactone, polycaprolactam, polyurethane, polymethacrylates (such as polymethyl methacrylate), polymethacrylic acid, polyacrylates (such as polymethyl acrylate), polyacrylic acid, polydienes (such as polybutadiene and polyisoprene), polyvinyl chloride, polyacetal, amine-capped alkylene oxides, polyphenylene oxide, poly(dimethylsiloxane), polytetrahydrofuran, polycyclohexylethylene, polyethyloxazoline, polyvinylpyridine, and polycaprolactone.

Polystyrene is especially preferred as the pore forming agent. Examples of the polystyrene include anionically polymerized polystyrene, syndiotactic polystyrene and unsubstituted and substituted polystyrenes (such as poly(α-methylstyrene)), among which the non-substituted polystyrene is preferred.

Thermoplastic polymers may also be used as the pore forming agent. Examples of the thermoplastic pore-forming polymer include polyacrylate, polymethacrylate, polybutadiene, polyisoprene, polyphenylene oxide, polypropylene oxide, polyethylene oxide, poly(dimethylsiloxane), polytetrahydrofuran, polyethylene, polycyclohexylethylene, polyethyloxazoline, polycaprolactone, polylactic acid and polyvinylpyridine.

Such pore forming agent has a boiling point or decomposition point of preferably from 100 to 500° C., more preferably from 200 to 450° C., especially preferably from 250 to 400° C. The molecular weight thereof is preferably from 200 to 50,000, more preferably from 300 to 10,000, especially preferably from 400 to 5,000 The pore forming agent is added in an amount, in terms of mass % relative to the film-forming polymer, of preferably from 0.5 to 75%, more preferably from 0.5 to 30%, especially preferably from 1 to 20%.

The polymer may contain a decomposable group as a pore forming factor. The decomposition point thereof is preferably from 100 to 500° C., more preferably from 200 to 450° C., especially from 250 to 400° C. The content of the decomposable group is, in terms of mole % relative to the amount of the monomer in the film-forming polymer, preferably from 0.5 to 75%, more preferably from 0.5 to 30%, especially preferably from 1 to 20%.

The film forming composition of the invention is used for film formation preferably after elimination therefrom of insoluble matters, gel-like components and the like by filtration through a filter. The filter to be used for such a purpose preferably has a pore size of from 0.001 to 0.2 μm, more preferably from 0.005 to 0.05 μm, most preferably from 0.005 to 0.03 μm. The filter is preferably made of PTFE, polyethylene or nylon, more preferably polyethylene or nylon.

The film can be formed by applying the film forming composition of the invention onto a substrate by a desired method such as spin coating, roller coating, dip coating or scan coating, and then heating the substrate to remove the solvent. For drying off the solvent, the substrate is heated preferably for 0.1 to 10 minutes at from 40 to 250° C.

As the method of applying the composition to the substrate, spin coating and scan coating are preferred, with spin coating being especially preferred. For spin coating, commercially available apparatuses such as “Clean Track Series” (trade name; product of Tokyo Electron), “D-spin Series” (trade name; product of Dainippon Screen), or “SS series” or “CS series” (each, trade name; product of Tokyo Oka Kogyo) are preferably employed. The spin coating may be performed at any rotation speed, but from the viewpoint of in-plane uniformity of the film, a rotation speed of about 1300 rpm is preferred for a 300-mm silicon substrate.

When the solution of the composition is discharged, either dynamic discharge in which the solution is discharged onto a rotating substrate or static discharge in which the solution is discharged onto a static substrate may be employed. The dynamic discharge is however preferred in view of the in-plane uniformity of the film. Alternatively, from the viewpoint of reducing the consumption amount of the composition, a method of discharging only a main solvent of the composition to a substrate in advance to form a liquid film and then discharging the composition thereon can be employed. Although no particular limitation is imposed on the spin coating time, it is preferably within 180 seconds from the viewpoint of throughput. From the viewpoint of the transport of the substrate, it is preferred to subject the substrate to processing (such as edge rinse or back rinse) for preventing the film from remaining at the edge portion of the substrate. The heat treatment method is not particularly limited, but ordinarily employed methods such as hot plate heating, heating with a furnace, heating in an RTP (Rapid Thermal Processor) to expose the substrate to light of, for example, a xenon lamp can be employed. Of these, hot plate heating or heating with a furnace is preferred. As the hot plate, a commercially available one, for example, “Clean Track Series” (trade name; product of Tokyo Electron), “D-spin Series” (trade name; product of Dainippon Screen) and “SS series” or “CS series” (trade name; product of Tokyo Oka Kogyo) is preferred, while as the furnace, “a series” (trade name; product of Tokyo Electron) is preferred.

It is especially preferred to apply the polymer of the invention onto a substrate and then heating to cure it. For this purpose, the polymerization reaction, at the time of post heating, of a carbon-carbon double bond or a carbon-carbon triple bond remaining in the polymer may be utilized. The post heat treatment is performed preferably at from 100 to 450° C., more preferably at from 200 to 420° C., especially preferably at from 350 to 400° C., preferably for from 1 minute to 2 hours, more preferably for from 10 minutes to 1.5 hours, especially preferably for from 30 minutes to 1 hour. The post heat treatment may be performed in several times. This post heat treatment is performed especially preferably in a nitrogen atmosphere in order to prevent thermal oxidation due to oxygen.

In the invention, the polymer may be cured not by heat treatment but by exposure to high energy radiation to cause polymerization reaction of a carbon-carbon double bond or carbon-carbon triple bond remaining in the polymer. Examples of the high energy radiation include electron beam, ultraviolet ray and X ray. The curing method is not particularly limited to these methods.

When electron beam is employed as high energy radiation, the energy is preferably from 0 to 50 keV, more preferably from 0 to 30 keV, especially preferably from 0 to 20 keV. Total dose of electron beam is preferably from 0 to 5 μC/cm² or less, more preferably from 0 to 2 μC/cm², especially preferably from 0 to 1 μC/cm² or less. The substrate temperature when it is exposed to electron beam is preferably from 0 to 450° C., more preferably from 0 to 400° C., especially preferably from 0 to 350° C. Pressure is preferably from 0 to 133 kPa, more preferably from 0 to 60 kPa, especially preferably from 0 to 20 kPa. The atmosphere around the substrate is preferably an atmosphere of an inert gas such as Ar, He or nitrogen from the viewpoint of preventing oxidation of the polymer of the invention. An oxygen, hydrocarbon or ammonia gas may be added for the purpose of causing reaction with plasma, electromagnetic wave or chemical species which is generated by the interaction with electron beam. In the invention, exposure to electron beam may be carried out in plural times. In this case, the exposure to electron beam is not necessarily carried out under the same conditions but the conditions may be changed every time.

Ultraviolet ray may be employed as high energy radiation. The radiation wavelength range of the ultraviolet ray is preferably from 190 to 400 nm, while its output immediately above the substrate is preferably from 0.1 to 2000 mWcm⁻². The substrate temperature upon exposure to ultraviolet ray is preferably from 250 to 450° C., more preferably from 250 to 400° C., especially preferably from 250 to 350° C. The atmosphere around the substrate is preferably an atmosphere of an inert gas such as Ar, He or nitrogen from the viewpoint of preventing oxidation of the polymer of the invention. The pressure at this time is preferably from 0 to 133 kPa.

When the film obtained using the film forming composition of the invention is used as an interlayer insulating film for semiconductor, a barrier layer for preventing metal migration may be disposed on the side of an interconnect. In addition, a cap layer, an interlayer adhesion layer or etching stopping layer may be disposed on the upper or bottom surface of the interconnect or interlayer insulating film to prevent exfoliation at the time of CMP (Chemical Mechanical Polishing). Moreover, the layer of an interlayer insulating film may be composed of plural layers using another material as needed.

The film obtained using the film forming composition of the invention can be etched for copper interconnection or another purpose. Either wet etching or dry etching can be employed, but dry etching is preferred. For dry etching, either ammonia plasma or fluorocarbon plasma can be used as needed. For the plasma, not only Ar but also a gas such as oxygen, nitrogen, hydrogen or helium can be used. Etching may be followed by ashing for the purpose of removing a photoresist or the like used for etching. Moreover, the ashing residue may be removed by washing.

The film obtained using the film forming composition of the invention may be subjected to CMP for planarizing the copper plated portion after copper interconnection. As a CMP slurry (chemical solution), a commercially available one (for example, product of Fujimi Incorporated, Rodel Nitta, JSR or Hitachi Chemical) can be used as needed. As a CMP apparatus, a commercially available one (for example, product of Applied Material or Ebara Corporation) can be used as needed. After CMP, the film can be washed in order to remove the slurry residue.

The film available using the film forming composition of the invention may be subjected to CMP (chemical mechanical polishing) for planarizing a copper plated portion after the copper wiring process. As the CMP slurry (chemical liquid), commercially available slurries (for example, products of Fujimi, Rodel-Nitta, JSR and Hitachi Chemical) are usable as needed. As the CMP apparatus, commercially available CMP apparatuses (for example, products of Applied Materials and Ebara) can be used as needed. The film may be rinsed after CMP in order to remove the slurry residue.

The film available using the insulating film forming composition of the invention can be used for various purposes. For example, it is suited for use as an insulating film in semiconductor devices such as LSI system LSI, DRAM, SDRAM, RDRAM and D-DRAM, and in electronic devices such as multi-chip module multi-layered wiring board. It can also be used as a passivation film or an α-ray shielding film for LSI, a coverlay film for flexographic printing plate, an overcoat film, a cover coating for a flexible copper-clad board, a solder resist film, and a liquid crystal alignment film as well as an interlayer insulating film for semiconductor, an etching stopper film, a surface protective film, and a buffer coating film. It is also usable as a surface protective film, antireflective film or phase difference film for optical apparatuses.

Use of the above-described method enables to obtain an insulating film with a low dielectric constant, more specifically, an insulating film having a specific dielectric constant of 2.7 or less, preferably 2.5 or less.

### EXAMPLE 1

The present invention will next be described more specifically by Examples.

### SYNTHESIS EXAMPLE 1

To 361 g of ethyl acetate was added 1 g of a mixture (Model Number: OL1170, product of Hybrid Plastics) of a cage-like silsesquioxane composed of 8 H₂C═CH—Si(O_{0.5})₃ units, a cage-like silsesquioxane composed of 10 H₂C═CH—Si(O_{0.5})₃ units, and a cage-like silsesquioxane composed of 12 H₂C═CH—Si(O_{0.5})₃ units. In a nitrogen gas stream, 95 μl of “Lupasol 11” (trade name; product of ARKEMA Yoshitomi) was added as a polymerization initiator to the resulting mixture, followed by reflux under heating for 5 hours. After cooling to room temperature, the mixture was concentrated under reduced pressure to a liquid mass of 2 g. Then, 20 ml of methanol was added and the mixture was stirred for 1 hour. A solid matter was collected by filtration and dried to obtain 0.83 g of a solid. GPC analysis of the solid resulted in Mw=178,000 and Mn=37,000. The solid was found to contain 1 mass % or less of an unreacted starting material. By using Waters 2695 and a GPC column (product of Shodex) for GPC, and drawing a calibration curve of a monomer by using an integrated value of an RI detector (Waters 2414), a monomer content in the solid was determined. The Mn and Mw of the solid were calculated based on a calibration curve drawn with standard polystyrene.

As a result of measurement of ¹H-NMR spectrum of the solid by using deuterized chloroform as a measuring solvent, a proton peak derived from alkyl groups and attributable to the polymerization of the vinyl groups and a proton peak derived from the remaining vinyl groups were observed at an integration ratio of 43:57. This suggests the polymerization of the vinyl groups.

When 5 ml of cyclohexanone was added to 0.3 g of the composition, followed by stirring at 40° C. for 3 hours, a uniform solution was obtained.

To the resulting solution was added 5 μl of “BYK 306” (trade name; product of BYK Chemie) as a surfactant, whereby a composition (mix-1) was obtained. From the mass of the remaining monomers and the mass of the additives, it is evident that a polymer obtained by the reaction between the vinyl groups of the monomers accounts for 60 mass % or greater of the solid content in the composition (mix-1).

### SYNTHESIS EXAMPLE 2

To 3 g of ethyl acetate was added 1.2 g of a cage-like silsesquioxane composed of 12H₂C═CH—Si(O_{0.5})₃ units which had been obtained by purifying the starting material used in Synthesis Example 1 (Model number: OL1170, product of Hybrid Plastics). In a nitrogen gas stream, 4 μl of “Lupasol 11” (trade name; product of ARKEMA Yoshitomi) was added as a polymerization initiator and the mixture was refluxed under heating for 5 hours. After the reaction mixture was cooled to room temperature and insoluble matters were filtered off, the residue was concentrated under reduced pressure to a liquid mass of 2 g. Then 20 ml of methanol was added and the mixture was stirred for 1 hour. The reaction mixture was filtered, followed by drying, whereby 0.32 g of a solid matter was obtained. GPC analysis of the solid matter resulted in Mw=8,000 and Mn=3,000. The solid matter contained 1 mass % or less of an unreacted starting material. Addition of 5 ml of cyclohexanone and stirring of the resulting mixture at 40° C. for 3 hours yielded a uniform solution. To the resulting solution was added 5 μl of “BYK 306” (trade name; product of BYK Chemie) as a surfactant, whereby a composition (T12-1) was obtained.

From the mass of the remaining monomers and the mass of the additives, it is evident that the polymer obtained by the reaction between the vinyl groups of the monomers accounts for 60 mass % or greater of the solid content in the composition.

### EXAMPLE 1

A coating solution was prepared by completely dissolving, in 10 g of cyclohexanone, 0.99 g of the composition obtained in Synthesis Example 1 and 0.01 g of tetrakis[methylene-3-(3,5-di-t-butyl-4-hydroxyphenyl)propionate]methane (“ADK Stab AO-60”, trade name; product of ADEKA). After filtration through a 0.1-μm filter made of tetrafluoroethylene, the resulting solution was spin-coated onto a silicon wafer. The resulting coat was heated at 200° C. for 60 seconds on a hot plate in a nitrogen gas stream, followed by baking for 60 minutes in a nitrogen-purged oven of 400° C., whereby a 0.5-μm thick uniform film free from seeding was formed. The film was stored for 24 hours in a thermo-hygrostat of 45° C. and 90% RH and then exposed to the air at 200° C. for 1 minute. The specific dielectric constant of the resulting film was calculated from the capacitance value thereof measured at 1 MHz by using a mercury probe (product of Four Dimensions) and an LCR meter “HP4285A” (trade name; product of Yokogawa Hewlett Packard). The specific dielectric constant was 2.42, while it was 2.41 just after the film formation. This has suggested that even under oxidation promotion conditions, no change occurred in a specific dielectric constant. In addition, no peak derived from the oxidation was found in the FT-IR spectrum.

### EXAMPLE 2

In a similar manner to Example 1 except for the use of the composition obtained in Synthesis Example 2 instead of the composition obtained in Synthesis Example 1 in Example 1, a coating solution was prepared and a film was formed. As a result, a uniform 0.5-μm film free from seeding was obtained. This film was stored for 24 hours in a thermo-hygrostat of 45° C. and 90% RH, followed by exposure to the atmosphere for 1 minute at 200° C. The specific dielectric constant of the film was calculated from the capacitance value at 1 MHz by using a mercury probe (product of Four Dimensions) and an LCR meter “HP4285A” (trade name; product of Yokogawa Hewlett-Packard). As a result, the specific dielectric constant was found to be 2.43, while it was 2.42 just after film formation. This has revealed that even under oxidation promotion conditions, no change occurred in a specific dielectric constant. In addition, no peak derived from oxidation was observed in the FT-IR spectrum.

### EXAMPLE 3

In a similar manner to Example 1 except for the use of bis-(2,2,6,6-tetramethyl-4-piperidinyl)sebacate (“ADK stab LA-77”, trade name; product of ADEKA) instead of “ADK stab AO-60” used in Example 1, a coating solution was prepared and a film was formed. As a result, a uniform 0.5-μm thick film free from seeding was obtained. This film was stored for 24 hours in a thermo-hygrostat of 45° C. and 90% RH, followed by exposure to the atmosphere for 1 minute at 200° C. The specific dielectric constant of the film was calculated from the capacitance value at 1 MHz by using a mercury probe (product of Four Dimensions) and an LCR meter “HP4285A” (trade name; product of Yokogawa Hewlett-Packard). As a result, the specific dielectric constant was found to be 2.43, while it was 2.41 just after film formation. This has revealed that even under oxidation promotion conditions, no change occurred in a specific dielectric constant. In addition, no peak derived from oxidation was observed in the FT-IR spectrum.

### EXAMPLE 4

In a similar manner to Example 1 except for the use of tetrakis(1,2,2,6,6-pentamethyl-4-piperidinyl)-1,2,3,4-butane tetracarboxylate (“ADK stab LA-52”, trade name; product of ADEKA) instead of “ADK stab AO-60” used in Example 1, a coating solution was prepared and a film was formed. As a result, a uniform 0.5-μm thick film free from seeding was obtained. This film was stored for 24 hours in a thermo-hygrostat of 45° C. and 90% RH, followed by exposure to the atmosphere for 1 minute at 200° C. The specific dielectric constant of the film was calculated from the capacitance value at 1 MHz by using a mercury probe (product of Four Dimensions) and an LCR meter “HP4285A” (trade name; product of Yokogawa Hewlett-Packard). As a result, the specific dielectric constant was found to be 2.41, while it was 2.41 just after film formation. This has revealed that even under oxidation promotion conditions, no change occurred in a specific dielectric constant. In addition, no peak derived from oxidation was observed in the FT-IR spectrum.

### EXAMPLE 5

In a similar manner to Example 1 except for the use of tetrakis(2,2,6,6-tetramethyl-4-piperidinyl)-1,2,3,4-butane tetracarboxylate (“ADK Stab LA-57”, trade name; product of ADEKA) instead of “ADK STAB AO-60” used in Example 1, a coating solution was prepared and a film was formed. As a result, a uniform 0.5-μm thick film free from seeding was obtained. The resulting film was stored for 24 hours in a thermo-hygrostat of 45° C. and 90% RH, followed by exposure to the atmosphere for 1 minute at 200° C. The specific dielectric constant of the film was calculated from the capacitance value at 1 MHz by using a mercury probe (product of Four Dimensions) and an LCR meter “HP4285A” (trade name; product of Yokogawa Hewlett-Packard). The specific dielectric constant was found to be 2.42, while that just after film formation was 2.41. This has revealed that no change occurred in a specific dielectric constant even under oxidation promotion conditions. In addition, no peak derived from the oxidation was observed in the FT-IR spectrum.

### COMPARATIVE EXAMPLE 1

In a similar manner to Example 1 except that “ADK stab AO-60” was not added, a coating solution was prepared and a film was formed. As a result, a uniform 0.5-μm thick film free from seeding was obtained. The resulting film was stored for 24 hours in a thermo-hygrostat of 45° C. and 90% RH, followed by exposure to the atmosphere for 1 minute at 200° C. The specific dielectric constant of the film was calculated from the capacitance value at 1 MHz by using a mercury probe (product of Four Dimensions) and an LCR meter “HP4285A” (trade name; product of Yokogawa Hewlett-Packard). As a result, the specific dielectric constant was found to be 2.62, while that just after film formation was 2.41. This has revealed that a change occurred in a specific dielectric constant under oxidation promotion conditions. In addition, a peak derived from the oxidation was observed apparently in the FT-IR spectrum.

The present invention makes it possible to provide a composition which is, as an interlayer insulating film material for use in a semiconductor device or the like, capable of forming a coat having an adequate and uniform thickness and in addition, suppressing a change in a dielectric constant of a film formed from the composition which will otherwise occur by the storage of the film under high humidity conditions; a production process of a film, a film, and a semiconductor device.

The entire disclosure of each and every foreign patent application from which the benefit of foreign priority has been claimed in the present application is incorporated herein by reference, as if fully set forth.

What is claimed is:

1. A film forming composition comprising:
a compound (I) having m pieces of RSi(O_{0.5})₃ units or a reaction product of the compound (I); and
an antioxidant,
wherein m represents an integer from 8 to 16;
each of Rs independently represents a non-hydrolyzable group; and
each of the units is liked with other units by sharing the oxygen atoms to form a cage structure.

2. The film forming composition according to claim 1,
wherein at least two of Rs represent a group having a vinyl group or ethynyl group.

3. The film forming composition according to claim 1,
wherein a polymer obtained by the reaction of a plurality of the compounds (I) accounts for 60 mass % or greater of a solid content in the composition.

4. The film forming composition according to claim 1,
wherein the reaction product of the compound (I) has, in the molecule thereof, at least 16 Si atoms.

5. The film forming composition according to claim 1,
wherein the antioxidant comprises at least one phenolic antioxidant.

6. The film forming composition according to claim 1,
wherein the antioxidant comprises at least one hindered amine antioxidant.

7. A production method of a film, comprising:
a process of applying the film forming composition according to claim 1 onto a substrate; and
a process of cure the film forming composition into a film.

8. A film produced by the production method according to claim 7.

9. A semiconductor device comprising the film according to claim 8.
